(19) United States
(12) Patent Application Publication
(10) Pub. No.: US 2024/0059806 A1
(43) Pub. Date: Feb. 22, 2024

(54) PROCESS FOR REMOVAL OF THIO-BASED END GROUPS FROM RAFT POLYMERS DERIVED FROM MONOMERS COMPRISING LACTAM AND ACRYLOYL MOIETIES

(71) Applicant: ISP Investments LLC, Wilmington, DE (US)

(72) Inventors: OSAMA M. MUSA, Bedminster, NJ (US); Rebecca Roisin GIBSON, Sheffield (GB); Steven Peter ARMES, Sheffield, Yorkshire (GB)

(73) Assignee: ISP Investments LLC, Wilmington, DE (US)

(21) Appl. No.: 18/259,972

(22) PCT Filed: Jan. 6, 2022
(86) PCT No.: PCT/US22/11431

§ 371 Date: Jun. 29, 2023

(51) Int. Cl. C08F 8/00

(52) U.S. Cl. CPC C08F 8/00; C08F 2438/03

(57) ABSTRACT

The invention provides a process for removal of a thio-based end group from a polymer comprising repeating units derived from at least one monomer comprising at least one acryloyl moiety and at least one functionalized or unfunctionalized lactam moiety by subjecting the polymer to radiation in a reaction medium devoid of any chemical reagent. Exemplary process involves removal of thio-based end groups from polymers prepared by reversible addition-fragmentation chain transfer polymerization of at least one monomer comprising at least one acryloyl moiety and at least one functionalized or unfunctionalized lactam moiety by exposing the polymer to visible radiation in a reaction medium devoid of any chemical reagent.

### BACKGROUND

### Field of the Invention

The disclosed and/or claimed inventive concept(s) provides a process for removal of thio-based end groups from RAFT polymers having repeating units derived from monomers comprising at least one acryloyl moiety and at least one functionalized or unfunctionalized lactam moiety by exposing the polymers to radiation in a suitable reaction medium devoid of chemical reagents.

### Description of Related Art

It is well-known that AB type of diblock copolymers undergo self-assembly both in the solid state and also in solution. In the latter case, a diverse range of copolymer morphologies has been reported, including spheres, worms, or vesicles. Typically, the copolymer chains are first prepared in a non-selective solvent and then subjected to either a gradual change in solvency or a pH switch in a separate step, which is typically undertaken in dilute solution.

In recent years, polymerization-induced self-assembly (PISA) of diblock copolymers in a solvent that is selective for the growing second block has become increasingly popular. PISA offers two decisive advantages over traditional processing methods: (i) syntheses can be conducted at up to 50% w/w solids and (ii) diblock copolymer nanoparticles are obtained directly, without requiring any post-polymerization processing steps. When combined with PISA, controlled radical polymerization techniques such as atom transfer radical polymerization (ATRP) or reversible addition-fragmentation chain transfer (RAFT) polymerization have enabled the preparation of a wide range of well-defined nanoparticles. RAFT dispersion polymerization is known to allow the efficient synthesis of pure spherical, worm-like or vesicular morphologies in aqueous, alcoholic, or non-polar media as well as ionic liquids.

Synthesis and self-assembly behaviors of well-defined poly(lauryl methacrylate)-block-poly [N-(2-methacryloylxyethyl)pyrrolidone] copolymers are described by Zhang and coworkers in Colloid and Polymer Science, 2013, Volume 291, 2653-2662.

Direct electrochemistry and electrocatalysis of hemoglobin immobilized in an amphiphilic diblock copolymer film is described by Jia and coworkers in Sensors & Actuators: B. Chemical, 2009, Volume 138, 244-250.

Facile synthesis and thermoresponsive behavior of a well-defined pyrrolidone based hydrophilic polymer is described by Deng and coworkers in Macromolecules, 2008, Volume 41, 3007-3014.

Effect of mild visible light on rapid aqueous RAFT polymerization of water-soluble acrylic monomers at ambient temperature: initiation and activation is described by Cai and coworkers in Macromolecules, 2009, Volume 42, 3917-3926.

Pyrrolidone-functional smart polymers via nitroxide-mediated polymerization is described by Savelyeva and coworkers in J Poly Sci. Part A Polymer Chem., 2014, Volume 52, Issue 14, 2011-2024.

Effect of molecular structure on thermoresponsive behaviors of pyrrolidone-based water-soluble polymers is described by Cai and coworkers in Macromolecules, 2010, volume 43, 4041-4049.

Carmean et. al. in ACS Macro Lett. 2017, Volume 6, Issue 2, pages 185-189 describe an initiator- and catalyst-free method for polymer end-group modification. Under long-wave ultraviolet irradiation, polymers with thiocarbonylthio end groups undergo photolytic cleavage to reveal an active macroradical capable of irreversible termination with a suitable hydrogen source. This straightforward method was successfully demonstrated by the removal of a range of end groups that commonly result from reversible addition-fragmentation chain transfer or photoiniferter polymerizations, including trithiocarbonate, dithiobenzoate, xanthate, and dithiocarbamate mediating agents. This strategy proved efficient for polymers derived from acrylamido, acrylic, methacrylic, styrenic, and vinylpyrrolidone monomers.

Kulai & coworkers in Polymer Chemistry, 2019, Volume 10, pages 267-277 describe synthesis and characterization of diblock copolymers of styrene and n-butyl acrylate using a new manganese RAFT agent and removal of the Mn-RAFT-ω-chain end by visible light irradiation led to the formation of a monomodal SH-terminated polymers.

Mattson and co-workers in Macromolecules, 2016, Volume 49, pages 8162-8166 used UV light (λ=380 nm) to remove terminal end-groups with a photoredox catalyst in solution (acetonitrile or N,N-dimethylacetamide).68 This method was shown to be compatible with many monomer classes and did not require elevated temperatures or deoxygenated conditions.

Discekici et al. in Chem. Comm., 2017, Volume 53, pages 1888-1891 were the first to report using visible light (λ=465 nm) to remove trithiocarbonate end-groups from polystyrene chains dissolved in dichloromethane. They found that using both an auxiliary amine and visible light was essential to produce a hydrogen chain-end, without the light, simple cleaving to a thiol end cap occurred.

Matioszek and co-workers in Macromol. Rapid Commun., 2015, Volume 36, pages 1354-1361 used ozonolysis to remove xanthate-based RAFT end-groups buried within the cores of relatively low molecular weight poly(n-butyl acrylate) latex particles in aqueous media.71 Complete removal of these RAFT end-groups was observed by UV-GPC analysis within 1 h at room temperature. Colloidal stability was maintained provided that the Mn of the latex was above 5 000 g mol⁻¹.

Recently, Jesson in Macromolecules, 2017, Volume 50, pages 182-191 et al. utilized H₂O₂ to remove RAFT chain-ends from aqueous dispersions of diblock copolymer nano-objects. In this case, 96% removal of dithiobenzoate end-groups from weakly hydrophobic poly(2-hydroxypropyl methacrylate) (PHPMA) cores was achieved within 8 h at 70° C. as judged by UV GPC analysis but this required using excess H₂O₂ as a reagent in the medium.

China patent CN 101775102B discloses a method for fast eliminating disulfide ester end groups of RAFT polymers involving adding a RAFT polymer solution and light triggers into a reaction vessel and carrying out photochemical reaction under the ultraviolet-visible light irradiation for the eliminating disulfide ester end groups of the RAFT polymers. The invention can solve the problem of each damage of functional groups such as epoxy functional groups, estolide functional groups and the like when nucleophilic reagents such as primary amine, secondary amine and the like are used for eliminating the disulfide ester end groups of the RAFT polymer.

It has been found that the thio-based end groups from RAFT polymers having repeating units derived from monomers comprising at least one acryloyl moiety and at least one functionalized or unfunctionalized lactam moiety can be efficiently and easily removed by exposing the polymer to visible radiation in a reaction medium that is devoid of any chemical reagent.

### SUMMARY

In a first aspect, the disclosed and/or claimed inventive concept(s) provides a process for removal of a thio-based end group from a polymer comprising repeating units derived from at least one monomer comprising at least one acryloyl moiety and at least one functionalized or unfunctionalized lactam moiety by exposing the polymer to radiation in a reaction medium that is devoid of chemical reagents.

In a second aspect, the disclosed and/or claimed inventive concept(s) provides a process for removal of a thio-based end group from a homopolymer comprising repeating units derived from a monomer comprising at least one acryloyl moiety and at least one functionalized or unfunctionalized lactam moiety by exposing the homopolymer to radiation in a reaction medium that is devoid of chemical reagents.

In a third aspect, the disclosed and/or claimed inventive concept(s) provides a process for removal of a thio-based end group from a block copolymer comprising repeating units derived from a monomer comprising at least one acryloyl moiety and at least one functionalized or unfunctionalized lactam moiety and at least one comonomer by exposing the copolymer to radiation in a reaction medium that is devoid of chemical reagents.

### DETAILED DESCRIPTION

Before explaining at least one aspect of the disclosed and/or claimed inventive concept(s) in detail, it is to be understood that the disclosed and/or claimed inventive concept(s) is not limited in its application to the details of construction and the arrangement of the components or steps or methodologies set forth in the following description or illustrated in the drawings. The disclosed and/or claimed inventive concept(s) is capable of other aspects or of being practiced or carried out in various ways. Also, it is to be understood that the phraseology and terminology employed herein is for the purpose of description and should not be regarded as limiting.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications referenced in any portion of this application are herein expressly incorporated by reference herein their entirety to the same extent as if each individual patent or publication was specifically and individually indicated to be incorporated by reference.

All of the articles and/or methods disclosed herein can be made and executed without undue experimentation in light of the present disclosure. While the articles and methods of the disclosed and/or claimed inventive concept(s) have been described in terms of aspects, it will be apparent to those of ordinary skill in the art that variations may be applied to the articles and/or methods and in the steps or in the sequence of steps of the method described herein without departing from the concept, spirit and scope of the disclosed and/or claimed inventive concept(s). All such similar substitutes and modifications apparent to those skilled in the art are deemed to be within the spirit, scope and concept of the disclosed and/or claimed inventive concept(s).

As utilized in accordance with the disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.”

Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B_{Xn}, B_{Xn+1}, or combinations thereof” is intended to include at least one of: A, B_{Xn}, B_{Xn+1}AB_{Xn}, A B_{Xn+1}, B_{Xn}B_{Xn+1}, or AB_{Xn}B_{Xn+1} and, if order is important in a particular context, also B_{Xn}A, B_{Xn+1}A, B_{Xn+1}B_{Xn}, B_{Xn+1}B_{Xn}A, B_{Xn}B_{Xn+1}A, AB_{Xn+1}B_{Xn}, B_{Xn}AB_{Xn+1}, or B_{Xn+1}AB_{Xn}. Continuing with this example, expressly included are combinations that contain repeats of one or more item or term, such as B_{Xn}B_{Xn}, AAA, MB_{Xn}, B_{Xn}B_{Xn}B_{Xn+1}, AAAB_{Xn}B_{Xn+1}B_{Xn+1}B_{Xn+1}B_{Xn+1}, B_{Xn+1}B_{Xn}B_{Xn}AAA, B_{Xn+1}AB_{Xn}B_{Xn}, and so forth. The skilled artisan will understand that typically there is no limit on the number of items or terms in any combination, unless otherwise apparent from the context.

The term “each independently selected from the group consisting of” means when a group appears more than once in a structure, that group may be selected independently each time it appears.

The term “hydrocarbyl” includes straight-chain and branched-chain alkyl, alkenyl, alkynyl, cycloalkyl, cycloalkenyl, aryl groups, and combinations thereof with optional heteroatom(s). A hydrocarbyl group may be mono-, di- or polyvalent.

The term “alkyl” refers to a functionalized or unfunctionalized, monovalent, straight-chain, branched-chain, or cyclic C₁-C₆₀ hydrocarbyl group optionally having one or more heteroatoms. In one non-limiting embodiment, an alkyl is a C₁-C₄₅ hydrocarbyl group. In another non-limiting embodiment, an alkyl is a C_{1-c30} hydrocarbyl group. Non-limiting examples of alkyl include methyl, ethyl, n-propyl, isopropyl, n-butyl, isobutyl, tent-butyl, n-pentyl, isopentyl, n-hexyl, n-heptyl, n-octyl, 2-ethylhexyl, tert-octyl, iso-norbornyl, n-dodecyl, tent-dodecyl, n-tetradecyl, n-hexadecyl, n-octadecyl, n-eicosyl, cyclobutyl, cyclopentyl, cyclohexyl, and the like. The definition of “alkyl” also includes groups obtained by combinations of straight-chain, branched-chain and/or cyclic structures.

The term “aryl” refers to a functionalized or unfunctionalized, monovalent, aromatic hydrocarbyl group optionally having one or more heteroatoms. The definition of aryl includes carbocyclic and heterocyclic aromatic groups. Non-limiting examples of aryl groups include phenyl, naphthyl, indenyl, indanyl, azulenyl, fluorenyl, anthracenyl, furyl, thienyl, pyridyl, pyrrolyl, oxazolyl, thiazolyl, imidazolyl, pyrazolyl, 2-pyrazolinyl, pyrazolidinyl, isoxazolyl, isothiazolyl, 1,2,3 -oxadiazolyl, 1,2,3 -triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3 -dihydrobenzofuranyl, benzo[b]thiophenyl, 1H-indazolyl, benzimidazolyl, benzthiazolyl, purinyl, 4H-quinolizinyl, isoquinolinyl, cinnolinyl, phthalazinyl, quinazolinyl, quinoxalinyl, 1,8-naphthridinyl, pteridinyl, carbazolyl, acridinyl, phenazinyl, phenothiazinyl, phenoxyazinyl, pyrazolo[1,5−c]triazinyl, and the like.

The term “aralkyl” refers to an alkyl group comprising one or more aryl substituent(s) wherein “aryl” and “alkyl” are as defined above. Non-limiting examples of aralkyl groups include benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like.

The term “alkylene” refers to a functionalized or unfunctionalized, divalent, straight-chain, branched-chain, or cyclic C₁-C₄₀ hydrocarbyl group optionally having one or more heteroatoms. In one non-limiting embodiment, an alkylene is a C₁-C₃₀ group. In another non-limiting embodiment, an alkylene is a C₁-C₂₀ group. Non-limiting examples of alkylene groups include:

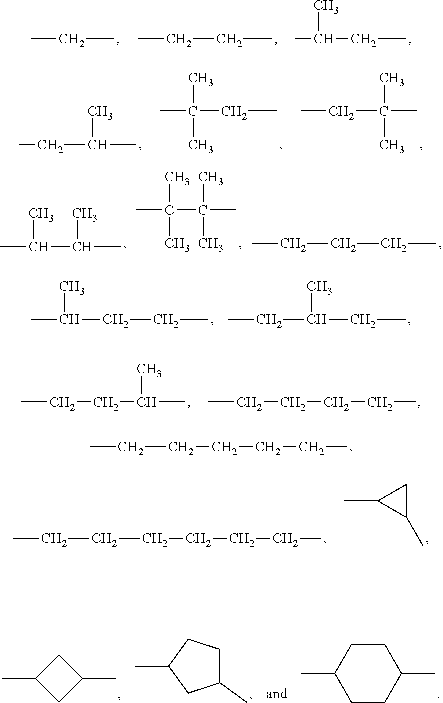

The term “arylene” refers to a functionalized or unfunctionalized, divalent, aromatic hydrocarbyl group optionally having one or more heteroatoms. The definition of arylene includes carbocyclic and heterocyclic groups. Non-limiting examples of arylene groups include phenylene, naphthylene, pyridinylene, and the like.

The term “heteroatom” refers to oxygen, nitrogen, sulfur, silicon, phosphorous, or halogen. The heteroatom(s) may be present as a part of one or more heteroatom-containing functional groups. Non-limiting examples of heteroatom-containing functional groups include ether, hydroxy, epoxy, carbonyl, carboxamide, carboxylic ester, carboxylic acid, imine, imide, amine, sulfonic, sulfonamide, phosphonic, and silane groups. The heteroatom(s) may also be present as a part of a ring such as in heteroaryl and heteroarylene groups.

The term “halogen” or “halo” refers to Cl, Br, I, or F.

The term “ammonium” includes protonated NH₃ and protonated primary, secondary, and tertiary organic amines.

The term “functionalized” with reference to any moiety refers to the presence of one or more functional groups in the moiety. Various functional groups may be introduced in a moiety by way of one or more functionalization reactions known to a person having ordinary skill in the art. Non-limiting examples of functionalization reactions include: alkylation, epoxidation, sulfonation, hydrolysis, amidation, esterification, hydroxylation, dihydroxylation, amination, ammonolysis, acylation, nitration, oxidation, dehydration, elimination, hydration, dehydrogenation, hydrogenation, acetalization, halogenation, dehydrohalogenation, Michael addition, aldol condensation, Canizzaro reaction, Mannich reaction, Clasien condensation, Suzuki coupling, and the like. In one non-limiting embodiment, the term “functionalized” with reference to any moiety refers to the presence of one more functional groups selected from the group consisting of alkyl, alkenyl, hydroxyl, carboxyl, halogen, alkoxy, amino, imino, and combinations thereof, in the moiety.

The term “monomer” refers to a small molecule that chemically bonds during polymerization to one or more monomers of the same or different kind to form a polymer.

The term “polymer” refers to a large molecule comprising one or more types of monomer residues (repeating units) connected by covalent chemical bonds. By this definition, polymer encompasses compounds wherein the number of monomer units may range from very few, which more commonly may be called as oligomers, to very many. Non-limiting examples of polymers include homopolymers, and non-homopolymers such as copolymers, terpolymers, tetrapolymers and the higher analogues. The polymer may have a random, block, and/or alternating architecture.

The term “homopolymer” refers to a polymer that consists essentially of a single monomer type.

The term “non-homopolymer” refers to a polymer that comprises more than one monomer types.

The term “copolymer” refers to a non-homopolymer that comprises two different monomer types.

The term “terpolymer” refers to a non-homopolymer that comprises three different monomer types.

The term “branched” refers to any non-linear molecular structure. The term includes both branched and hyper-branched structures.

The term “block copolymer” refers to a polymer comprising at least two blocks of polymerized monomers. Any block may be derived from either a single monomer resulting in a homopolymeric subunit, or two or more monomers resulting in a copolymeric (or non-homopolymeric) subunit in the block copolymer. The block copolymers may be diblock copolymers (i.e., polymers comprising two blocks of monomers), triblock copolymers (i.e., polymers comprising three blocks of monomers), multiblock copolymers (i.e., polymers comprising more than three blocks of monomers), and combinations thereof. The block copolymers may be linear, branched, star or comb like, and have structures such as [A][B], [A][B][A], [A][B][C], [A][B][A][B], [A][B][C][B], etc. An exemplary representation of block copolymer is [A]ₓ[B]_{y} or [A]ₓ[B]_{y}[C]_{z}, wherein x, y and z are the degrees of polymerization (DP) of the corresponding blocks [A], [B], and [C]. Additional insight into the chemistry, characterization and applications of block copolymers may be found in the book ‘Block Copolymers: Synthetic Strategies, Physical Properties, and Applications’, by Nikos Hadjichristidis, Stergios Pispas, and George Floudas, John Wiley and Sons (2003), the contents of which are herein incorporated in its entirety by reference.

The term “controlled radical polymerization” refers to a specific radical polymerization process, also denoted by the term of “living radical polymerization”, in which use is made of control agents, such that the block copolymer chains being formed are functionalized by end groups capable of being reactivated in the form of free radicals by virtue of reversible transfer or reversible termination reactions.

The term “addition-fragmentation” refers to a two-step chain transfer mechanism during polymerization leading to homopolymers and block copolymers wherein a radical addition is followed by fragmentation to generate a new radical species.

The term RAFT refers to reversible addition-fragmentation chain transfer.

The term “free radical addition polymerization initiator” refers to a compound used in a catalytic amount to initiate a free radical addition polymerization. The choice of initiator depends mainly upon its solubility and its decomposition temperature.

The term “alkyl acrylate” refers to an alkyl ester of an acrylic acid or an alkyl acrylic acid.

The term “alkyl acrylamide” refers to an alkyl amide of an acrylic acid or an alkyl acrylic acid.

The term “moiety” refers to a part or a functional group of a molecule.

The term “hydrophilic monomer” refers to a monomer having solubility in water of greater than about 10 percent by weight at 25° C.

All percentages, ratio, and proportions used herein are based on a weight basis unless other specified.

In a first aspect, the disclosed and/or claimed inventive concept(s) provides a process for removal of a thio-based end group from a polymer comprising repeating units derived from at least one monomer comprising at least one acryloyl moiety and at least one functionalized or unfunctionalized lactam moiety by exposing the polymer to radiation in a reaction medium that is devoid of chemical reagents.

In a second aspect, the disclosed and/or claimed inventive concept(s) provides a process for removal of a thio-based end group from a homopolymer comprising repeating units derived from a monomer comprising at least one acryloyl moiety and at least one functionalized or unfunctionalized lactam moiety by exposing the homopolymer to radiation in a reaction medium that is devoid of chemical reagents.

In a third aspect, the disclosed and/or claimed inventive concept(s) provides a process for removal of a thio-based end group from a block copolymer comprising repeating units derived from a monomer comprising at least one acryloyl moiety and at least one functionalized or unfunctionalized lactam moiety and at least one comonomer by exposing the copolymer to radiation in a reaction medium that is devoid of chemical reagents.

In one non-limiting embodiment, the radiation is visible radiation.

In another non-limiting embodiment, the radiation is visible radiation has a wavelength ranging from about 380 to about 700 nanometers.

In one non-limiting embodiment, the thio-based end group is a thio-based moiety resulting from reversible addition-fragmentation chain transfer polymerization of one or more monomers.

In one non-limiting embodiment, the monomer comprising at least one acryloyl moiety and at least one functionalized or unfunctionalized lactam moiety has a structure:

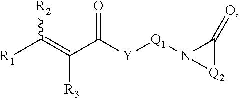

wherein each R₁ R₂ and R₃ is independently selected from the group consisting of hydrogen, halogens, functionalized and unfunctionalized Ci-C4 alkyl, and

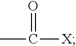

each X is independently selected from the group consisting of OR₄, OM, halogen, N(R₅)(R₆),

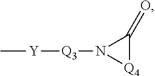

and combinations thereof; each Y is independently oxygen, NR₇ or sulfur; each R₄, R₅, R₆ and R₇ is independently selected from the group consisting of hydrogen, functionalized and unfunctionalized alkyl, and combinations thereof; each M is independently selected from the group consisting of metal ions, ammonium ions, organic ammonium cations, and combinations thereof; and each Q₁, Q₂, Q₃, and Q₄ is independently a functionalized or unfunctionalized alkylene.

In one non-limiting embodiment, each Q₁, Q₂, Q₃, and Q₄ is independently selected from the group consisting of functionalized and unfunctionalized C₁-C₁₂ alkylene. Non-limiting examples of such alkylene groups include —CH₂—, —CH₂—CH₂—, —CH(CH₃)—CH₂—, —CH₂—CH(CH₃)—, —C(CH₃)₂—CH₂—, —CH₂—C(CH₃)₂—, —CH(CH₃)—CH(CH₃)—, —C(CH₃)₂—C(CH₃)₂—, —CH₂—CH₂—CH₂—, —CH(CH₃)—CH₂—CH₂—, —CH₂—CH(CH₃)—CH₂—, —CH₂—CH₂—CH(CH₃)—,—CH₂CH₂—CH₂—CH₂—, —CH₂—CH₂—CH₂—CH₂—CH₂—, —CH₂—CH₂—CH₂—CH₂—CH₂—CH₂—, and —CH₂—CH₂—CH₂—CH₂—CH₂—CH₂—CH₂—.

In another non-limiting embodiment, each Q₁, Q₂, Q₃, and Q₄ is independently selected from the group consisting of functionalized and unfunctionalized C₂ C₆ alkylene. Non-limiting examples of such alkylene groups include:

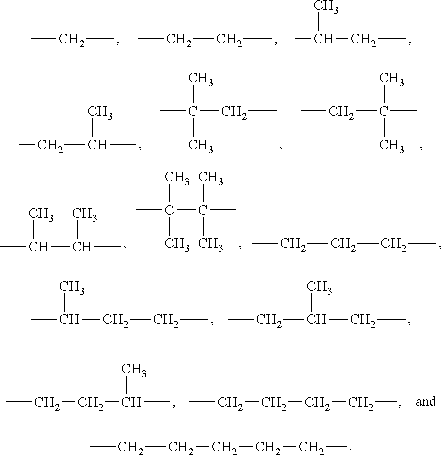

In one non-limiting embodiment, each R₁, R₂ and R₃ is independently selected from the group consisting of hydrogen, methyl and combinations thereof In another non-limiting embodiment, R₁ and R₂ are hydrogens and R₃ is hydrogen or methyl.

In another non-limiting embodiment, each R₁ and R₃ is independently hydrogen or methyl; R₂ is

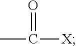

X is selected from the group consisting of OR₄, OM, halogens, and N(R₅)(R₆); each R₄, R₅, and R₆ is independently selected from the group consisting of hydrogen and functionalized and unfunctionalized alkyl; and each M is independently selected from the group consisting of metal ions, ammonium ions, organic ammonium cations, and combinations thereof.

In yet another non-limiting embodiment, R₁ and R₃ are hydrogens and R₂ is

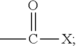

X is selected from the group consisting of OR₄, OM and N(R₅)(R₆); each R₄, R₅, and R₆ is independently selected from the group consisting of hydrogen and functionalized and unfunctionalized c₁-C₄ alkyl; and each M is independently selected from the group consisting of metal ions, ammonium ions, organic ammonium cations, and combinations thereof

In one non-limiting embodiment, the monomer comprising at least one acryloyl moiety and at least one functionalized or unfunctionalized lactam moiety has a structure selected from the group consisting of:

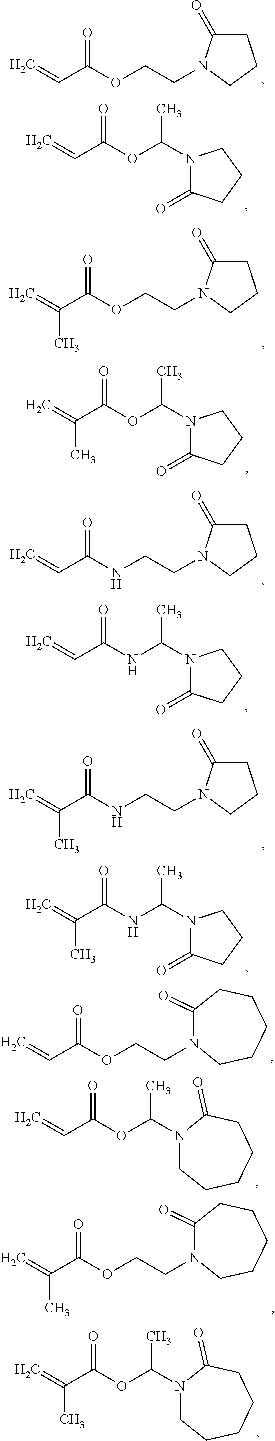

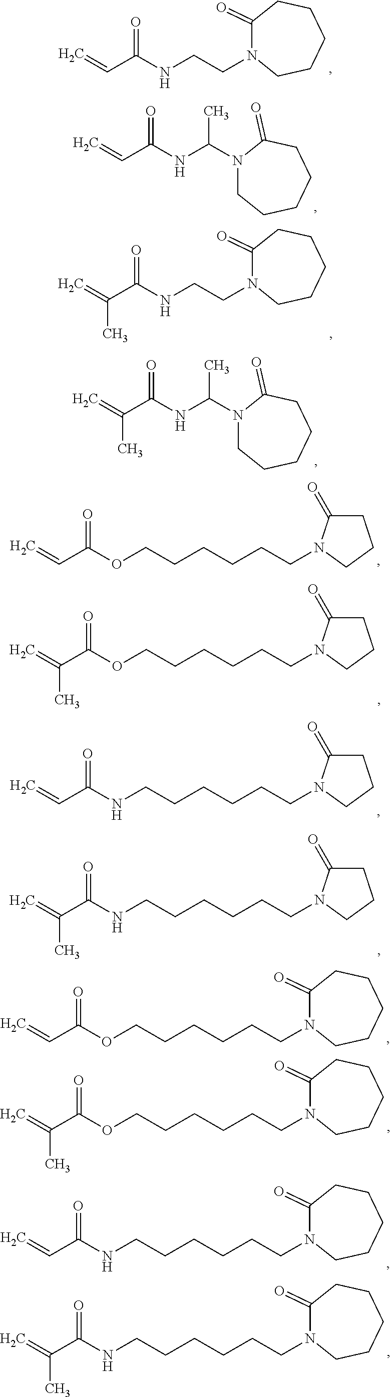

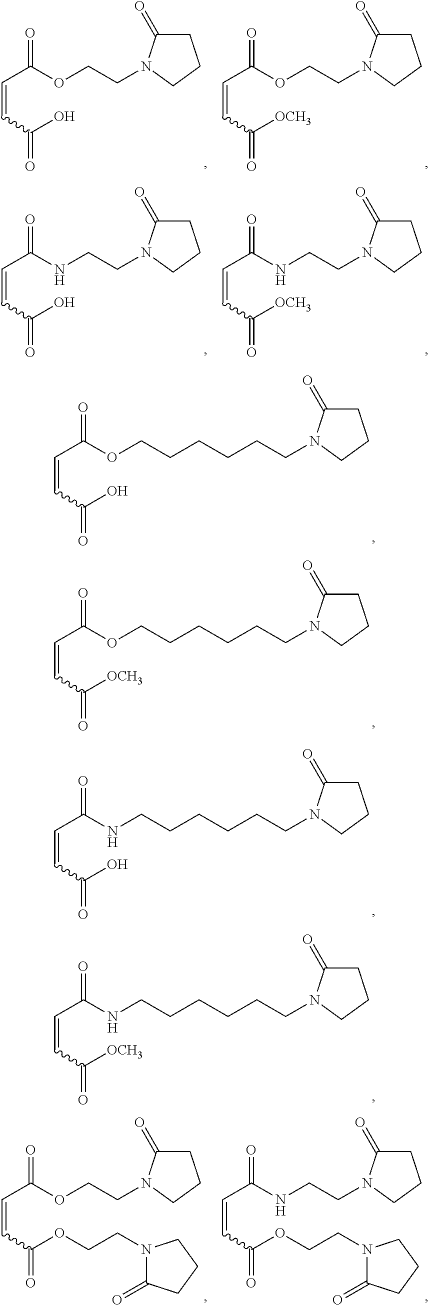

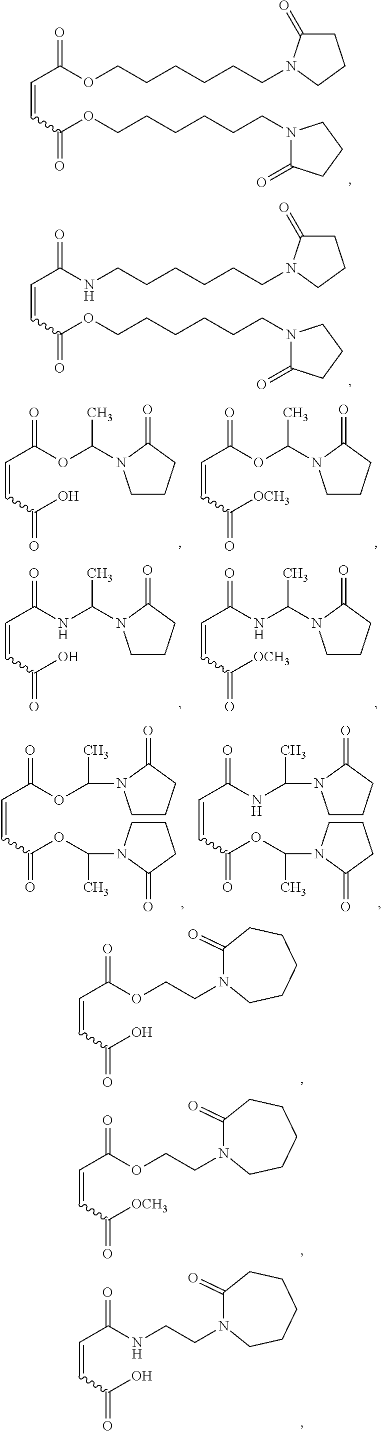

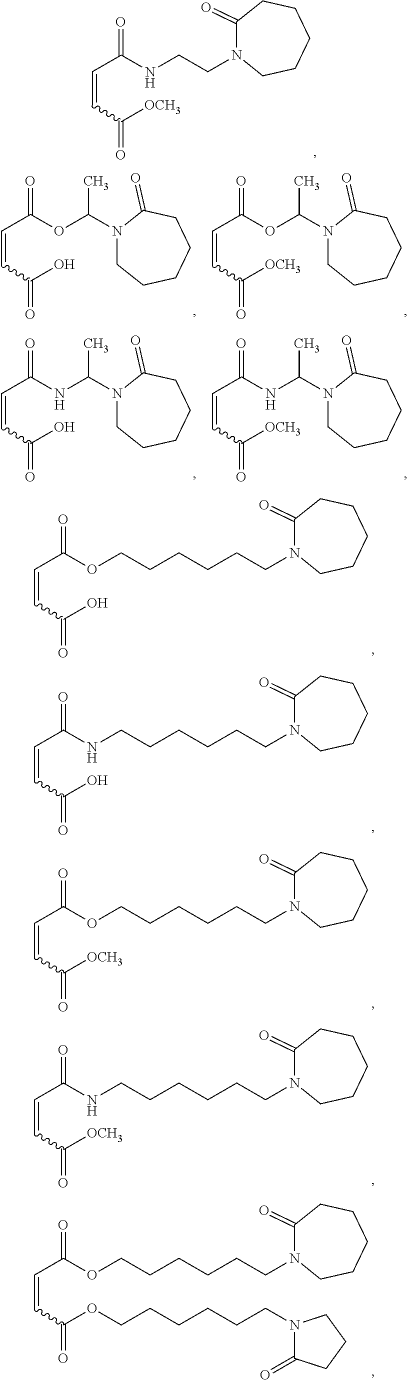

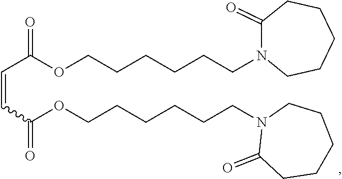 [SMILES: O=C(C=CC(=O)OCCCCCCN1CCCCCC1=O)OCCCCCCN1CCCCCC1=O]

and combinations thereof.

In one non-limiting embodiment, the polymer is a homopolymer, diblock copolymer, or a multiblock polymer.

In one non-limiting embodiment, the comonomer is selected from the group consisting of hydrophilic comonomers, hydrophobic comonomers, and combinations thereof.

In one non-limiting embodiment, the hydrophilic comonomer is selected from the group consisting of functionalized or unfunctionalized hydroxyalkyl (meth)acrylates, glyceryl (meth)acrylates, epoxyalkyl (meth)acrylates, N-alkylaminoalkyl (meth)acrylates, N,N-dialkylaminoalkyl (meth)acrylates, oligoethyleneglycol (meth)acrylates, etherified oligoethyleneglycol (meth)acrylates, polyalkyleneglycol (meth)acrylates, etherified polyalkyleneglycol (meth)acrylates, (meth)acrylamides, N-alkyl(meth)acrylamides, N,N-dialkyl(meth)acryl amides, N-hydroxyalkyl (meth)acrylamides, N-epoxyalkyl (meth)acrylamides, N-aminoalkyl (meth)acrylamides, N,N-dialkylaminoalkyl (meth)acrylamides, (meth)acrylates and (meth)acrylamides comprising sulfonic acid moieties and salts thereof, alkenyl sulfonic acids and salts thereof, (meth)acrylates and (meth)acrylamides comprising quaternary ammonium moieties, N-vinyl lactams, N-vinyl pyrrolidone, vinyl alcohol, N-alkenyl carboxamides, alpha-beta unsaturated dicarboxylic acids and salts thereof, alpha-beta unsaturated dicarboxylic anhydrides, amic acids, ester acids and salts thereof, diesters, diamides, esteramides, and combinations thereof.

In one non-limiting embodiment, the hydrophobic comonomer is selected from the group consisting of functionalized or unfunctionalized styrene, vinyl chloride, vinyl 2-ethylhexanoate, vinyl laurate, vinyl stearate, vinyl neo-pentanoate, vinyl 2-ethylhexanoate, vinyl neo-nonanoate, vinyl neo-decanoate, vinyl neo-undecanoate, vinyl neo-dodecanoate, isobutyl vinyl ether, 2-chloroethyl vinyl ether, stearyl vinyl ether, n-butyl acrylate, isobutyl acrylate, sec-butyl acrylate, tert-butyl acrylate, n-pentyl acrylate, neopentyl acrylate, n-hexyl acrylate, n-heptyl acrylate, n-octyl acrylate, isooctyl acrylate, isononyl acrylate, n-decyl acrylate, isodecyl acrylate, 2-ethylhexyl acrylate, benzyl acrylate, oleyl acrylate, palmityl acrylate, stearyl acrylate, n-butyl methacrylate, isobutyl methacrylate, sec-butyl methacrylate, tert-butyl methacrylate, n-pentyl methacrylate, neopentyl methacrylate, n-hexyl methacrylate, n-heptyl methacrylate, n-octyl methacrylate, isooctyl methacrylate, isononyl methacrylate, n-decyl methacrylate, isodecyl methacrylate, 2-ethylhexyl methacrylate, benzyl methacrylate, oleyl methacrylate, palmityl methacrylate, stearyl methacrylate, lauryl methacrylate, unsaturated vinyl esters of (meth)acrylic acid such as those derived from fatty acids and fatty alcohols, monomers derived from cholesterol, vinyl chloride, 1-butene, 2-butene, 1-pentene, 1-hexene, 1-octene, isobutylene, isoprene, and combinations thereof.

### Methods of Synthesis

RAFT polymerization is one of the most robust and versatile methods for providing living characteristics to radical polymerization. With appropriate selection of the RAFT agent for the monomers and reaction conditions, it is applicable to majority of monomers subject to radical polymerization. The process can be used in the synthesis of well-defined homo-, gradient, diblock, triblock, and star polymers and more complex architectures, which include microgels and polymer brushes.

When preparing, for example, a block copolymer in the presence of the control agent, the end of the growing block is provided with a specific functionality that controls the growth of the block by means of reversible free radical deactivation. The functionality at the end of the block is of such a nature that it can reactivate the growth of the block in a second and/or third stage of the polymerization process with other ethylenically unsaturated monomers providing a covalent bond between, for example, a first and second block [A] and [B] and with any further optional blocks.

Further details on the chemistry of synthesis of block copolymers by RAFT processes may be found in the following publications, each of which is herein incorporated in its entirety by reference: Polymer, 2008, volume 49, 1079-1131; Chemical Society Reviews, 2014, volume 43, 496-505; Macromolecules, 1998, volume 31, 5559-5562; and Polymer, 2013, volume 54, 2011-2019.

In one non-limiting embodiment, the reversible transfer agents may be one or more thio-based compounds selected from the group consisting of dithioesters, thioethers-thiones, trithiocarbonates, dithiocarbamates, xanthates and mixtures thereof.

The processes according to the disclosed and/or claimed inventive concept(s) may be illustrated according to the examples set out below. These examples are presented herein for purposes of illustration of the disclosed and/or claimed inventive concept(s) and are not intended to be limiting, for example, the process of removal of thio-based end groups from RAFT polymers. In the examples, the following abbreviations are used:
NMEP: N-2-(methacryloyloxy)ethyl pyrrolidone
LMA: Lauryl (meth)acrylate
PNMEP: Poly(N-2-(methacryloyloxy)ethyl pyrrolidone)
PLMA: Poly(lauryl (meth)acrylate)
GPC: Gel permeation chromatography

### EXAMPLES

An aqueous dispersion of PNMEP₂₈-PLMA₈₇ diblock copolymer nanoparticles was diluted to 7.5% w/w using deionized water and exposed to 405 nm light at 50° C. with continuous stirring. The rate of RAFT end-group removal was monitored for 4.5 h using UV GPC. UV GPC chromatograms were normalized with respect to the refractive index signal. After 60 min, 81% of the RAFT end-groups were removed. After 3 h, only 4% of the original RAFT end-groups remained.

What we claim is

1. A process for removal of a thio-based end group from a polymer comprising repeating units derived from at least one monomer comprising at least one acryloyl moiety and at least one functionalized or unfunctionalized lactam moiety said process comprising exposing said polymer to radiation in a reaction medium devoid of chemical reagents.

2. The process according to claim 1 wherein said radiation is visible radiation.

3. The process according to claim 2 wherein said visible radiation has a wavelength ranging from about 380 to about 700 nanometers.

4. The process according to claim 1 wherein said thio-based end group is a thio-based moiety resulting from radical addition-fragmentation chain transfer polymerization of said at least one monomer.

5. The process according to claim 1 wherein said monomer comprising at least one acryloyl moiety and at least one functionalized or unfunctionalized lactam moiety has a structure: 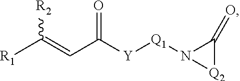
wherein each R₁ and R₂ is independently selected from the group consisting of hydrogen, halogens, functionalized and unfunctionalized C₁-C₄ alkyl, and 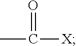
each X is independently selected from the group consisting of OR₃, OM, halogen, N(R₄)(R₅), 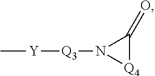
and combinations thereof;
each Y is independently oxygen, NR₆ or sulfur;
each R₃, R₄, R₅, and R₆ is independently selected from the group consisting of hydrogen, functionalized and unfunctionalized alkyl, and combinations thereof;
each M is independently selected from the group consisting of metal ions, ammonium ions, organic ammonium cations, and combinations thereof; and
each Q₁, Q₂, Q₃, and Q₄ is independently a functionalized or unfunctionalized alkylene.

6. The process according to claim 5 wherein said R₁ is hydrogen or methyl; said R₂ is 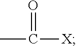
X is selected from the group consisting of OR₃, OM, halogens, and N(R₄)(R₅); each R₃, R₄, and R₅ is independently selected from the group consisting of hydrogen and functionalized and unfunctionalized alkyl; and each M is independently selected from the group consisting of metal ions, ammonium ions, organic ammonium cations, and combinations thereof.

7. The process according to claim 5 wherein said monomer has a structure selected from the group consisting of: 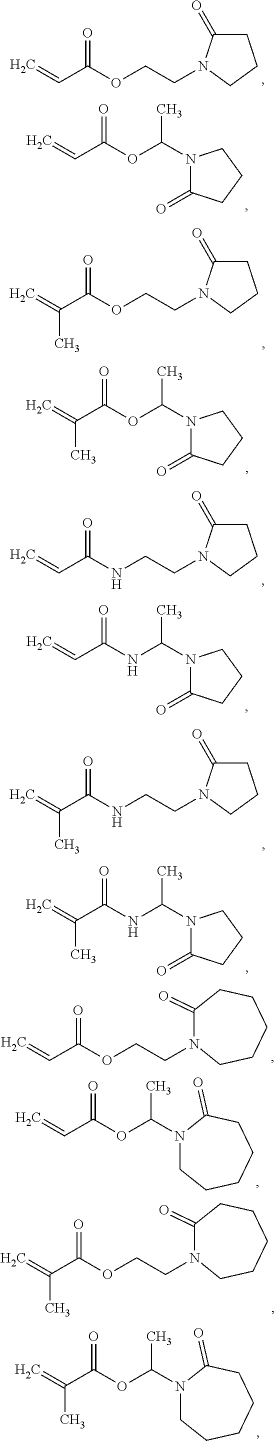 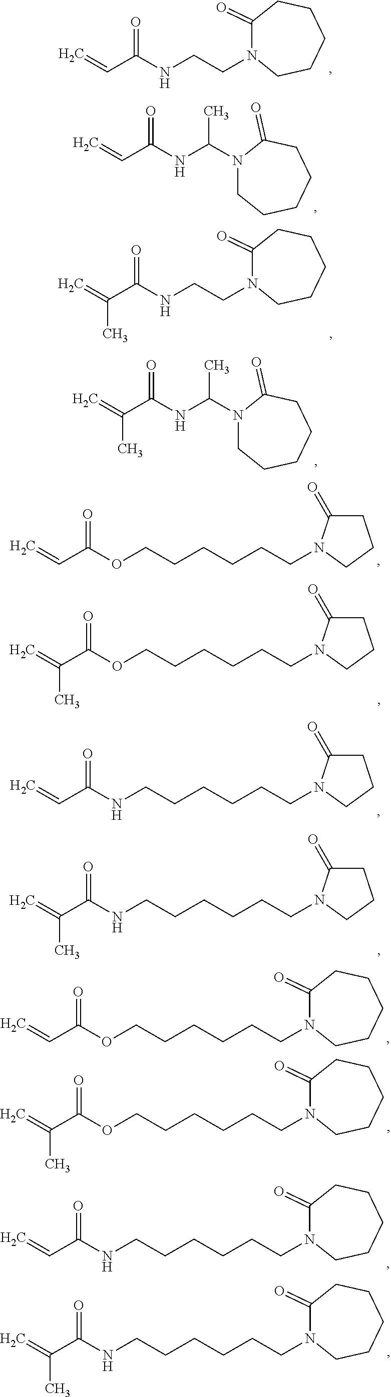 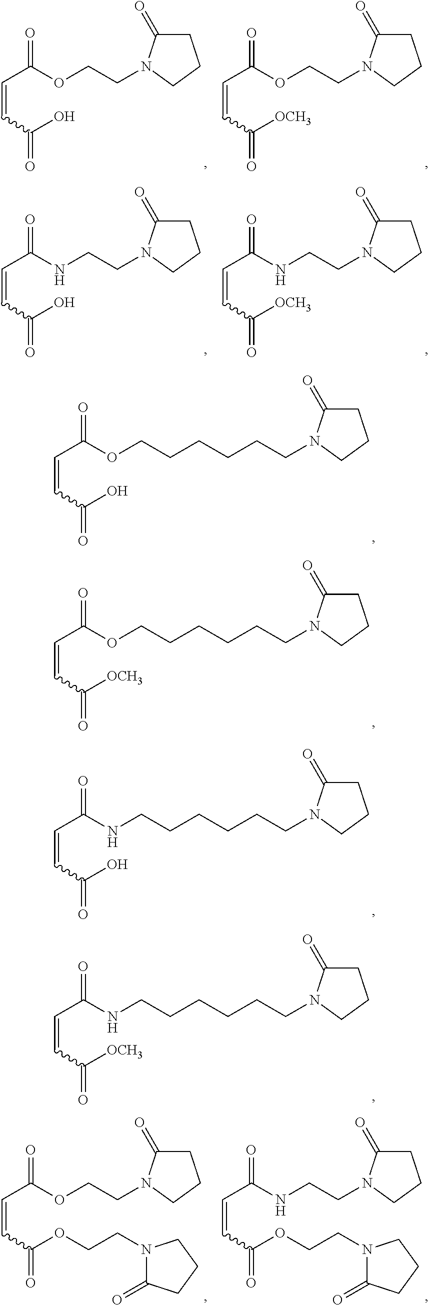 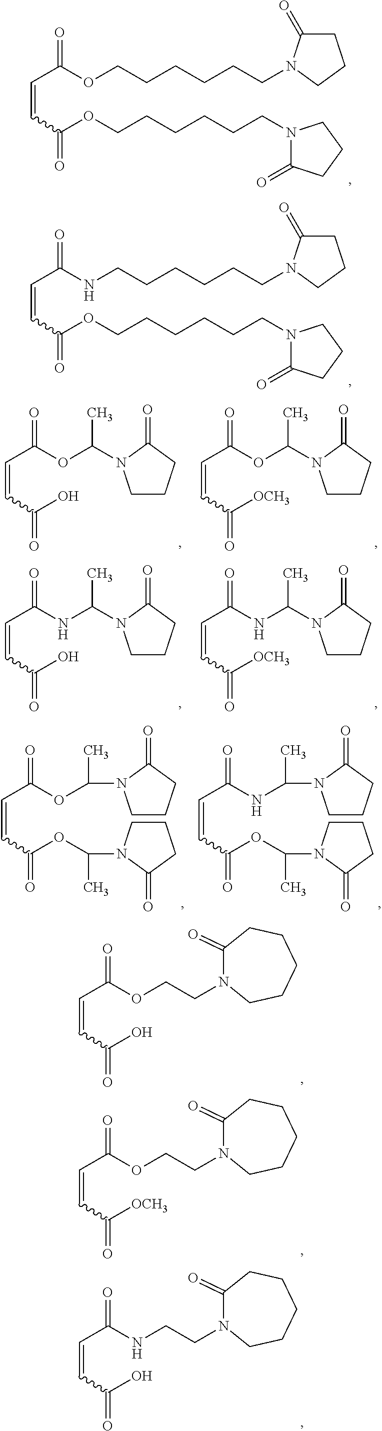 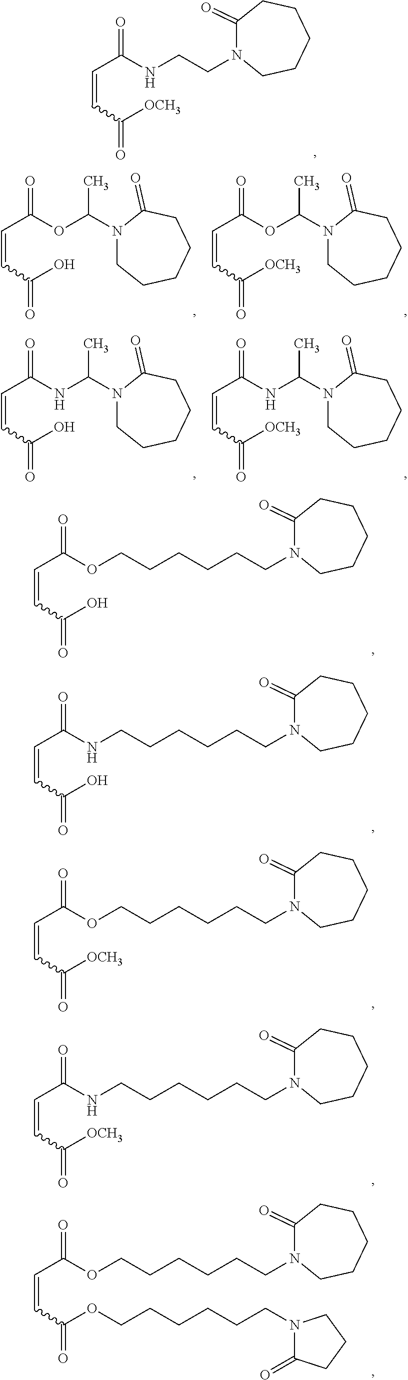 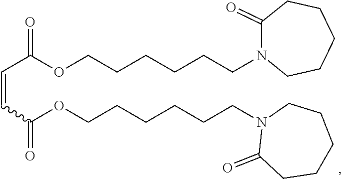 [SMILES: O=C(C=CC(=O)OCCCCCCN1CCCCCC1=O)OCCCCCCN1CCCCCC1=O]
and combinations thereof.

8. The process according to claim 1 wherein said polymer is a homopolymer, diblock copolymer, or a multiblock polymer.

9. A process for removal of a thio-based end group from a homopolymer consisting of repeating units derived from a monomer comprising at least one acryloyl moiety and at least one functionalized or unfunctionalized lactam moiety said process comprising exposing said homopolymer to radiation in a reaction medium devoid of chemical reagents.

10. A process for removal of a thio-based end group from a block copolymer comprising repeating units derived from at least one monomer comprising at least one acryloyl moiety and at least one functionalized or unfunctionalized lactam moiety and at least one comonomer said process comprising exposing said copolymer to radiation in a reaction medium devoid of chemical reagents.

11. The process according to claim 10 wherein said comonomer is selected from the group consisting of hydrophilic comonomers, hydrophobic comonomers, and combinations thereof.

12. The process according to claim 11 wherein said hydrophilic comonomer is selected from the group consisting of functionalized or unfunctionalized hydroxyalkyl (meth)acrylates, glyceryl (meth)acrylates, epoxyalkyl (meth)acrylates, N-alkylaminoalkyl (meth)acrylates, N,N-dialkylaminoalkyl (meth)acrylates, oligoethyleneglycol (meth)acrylates, etherified oligoethyleneglycol (meth)acrylates, polyalkyleneglycol (meth)acrylates, etherified polyalkyleneglycol (meth)acrylates, (meth)acrylamides, N-alkyl(meth)acrylamides, N,N-dialkyl(meth)acryl amides, N-hydroxyalkyl (meth)acrylamides, N-epoxyalkyl (meth)acrylamides, N-aminoalkyl (meth)acrylamides, N,N-dialkylaminoalkyl (meth)acrylamides, (meth)acrylates and (meth)acrylamides comprising sulfonic acid moieties and salts thereof, alkenyl sulfonic acids and salts thereof, (meth)acrylates and (meth)acrylamides comprising quaternary ammonium moieties, N-vinyl lactams, N-vinyl pyrrolidone, vinyl alcohol, N-alkenyl carboxamides, alpha-beta unsaturated dicarboxylic acids and salts thereof, alpha-beta unsaturated dicarboxylic anhydrides, amic acids, ester acids and salts thereof, diesters, diamides, esteramides, and combinations thereof.

13. The process according to claim 11 wherein said hydrophobic comonomer is selected from the group consisting of functionalized or unfunctionalized styrene, vinyl chloride, vinyl 2-ethylhexanoate, vinyl laurate, vinyl stearate, vinyl neo-pentanoate, vinyl 2-ethylhexanoate, vinyl neo-nonanoate, vinyl neo-decanoate, vinyl neo-undecanoate, vinyl neo-dodecanoate, isobutyl vinyl ether, 2-chloroethyl vinyl ether, stearyl vinyl ether, n-butyl acrylate, isobutyl acrylate, sec-butyl acrylate, tert-butyl acrylate, n-pentyl acrylate, neopentyl acrylate, n-hexyl acrylate, n-heptyl acrylate, n-octyl acrylate, isooctyl acrylate, isononyl acrylate, n-decyl acrylate, isodecyl acrylate, 2-ethylhexyl acrylate, benzyl acrylate, oleyl acrylate, palmityl acrylate, stearyl acrylate, n-butyl methacrylate, isobutyl methacrylate, sec-butyl methacrylate, tert-butyl methacrylate, n-pentyl methacrylate, neopentyl methacrylate, n-hexyl methacrylate, n-heptyl methacrylate, n-octyl methacrylate, isooctyl methacrylate, isononyl methacrylate, n-decyl methacrylate, isodecyl methacrylate, 2-ethylhexyl methacrylate, benzyl methacrylate, oleyl methacrylate, palmityl methacrylate, stearyl methacrylate, lauryl methacrylate, unsaturated vinyl esters of (meth)acrylic acid such as those derived from fatty acids and fatty alcohols, monomers derived from cholesterol, vinyl chloride, 1-butene, 2-butene, 1-pentene, 1-hexene, 1-octene, isobutylene, isoprene, and combinations thereof.

14. The process according to claim 9 or 10 wherein said radiation is visible radiation.

15. The process according to claim 14 wherein said visible radiation has a wavelength ranging from about 380 to about 700 nanometers.
